(19) United States
(12) Patent Application Publication
(10) Pub. No.: US 2006/0139330 A1
(43) Pub. Date: Jun. 29, 2006

(54) Adaptive mouse re-direction

(76) Inventors: Patrick G. Kutch, Beaverton, OR (US); Keith E. Kroeker, Hubbard, OR (US)

Correspondence Address: Buckley, Maschoff & Talwalkar LLC;Attorneys for INTEL Corporation, Five Elm Street, New Canaan, CT, 06840, US

(21) Appl. No.: 11/025,106

(22) Filed: Dec. 29, 2004

(51) Int. Cl. G09G 5/08

(52) U.S. Cl. 345/163

(57) ABSTRACT

A method includes detecting the type of a first mouse, and receiving data generated by a second mouse. The method further includes determining whether to modify the format of the received data. The determination is made at least in part on the detected type of the first mouse.

### BACKGROUND

Client/server computing systems are in widespread use. The client device is typically a personal computer which provides to the client user an interface via input/output (I/O) devices such as a keyboard, mouse and video display monitor coupled to the personal computer.

For administrative purposes similar I/O devices may be coupled to the server to allow direct user input at the server location.

A technique referred to as KVM (Keyboard Video and Mouse) re-direction has been proposed to allow control of a server from I/O devices coupled to a client device. With KVM re-direction, input signals from the client's keyboard and/or mouse are captured by a KVM application program running on the client and are formatted for transmission to the server. The server OS (operating system) receives the client KVM input and generates a video output that reflects the client KVM input. The server OS video output is transmitted to the client and displayed in a window on the client video display monitor.

The present inventors have observed a problem that may be encountered with KVM re-direction in regard to mouse data packet formats.

When the server OS is in a start-up mode, it typically surveys the server's peripheral devices and determines, among other parameters, what type of mouse is locally connected to the server. The type of local mouse that is detected determines what format of mouse data (typically 3-byte packets versus 4-byte packets) the OS expects to receive. Thereafter, a KVM re-direction operation may occur and the server OS may receive mouse data packets from a mouse connected to a remote client. If the client mouse is of a different type from the server mouse, so that the KVM re-direction data from the client is in a different format from the mouse data format anticipated by the OS from the server mouse, disruption of the server OS may occur. In particular, after receiving KVM re-directed mouse data in an unexpected format, the OS may fail to respond to both the local server mouse and to the KVM re-directed mouse data from the client mouse.

### BRIEF DESCRIPTION OF THE DRAWINGS

FIG. 1 is a block diagram of a computer system provided according to some embodiments.

FIG. 2 is a block diagram showing some details of a server computer that is part of the computer system of FIG. 1.

FIG. 3 is a flow chart that illustrates a portion of a start-up procedure performed in the server computer of the computer system of FIG. 1.

FIG. 4 is a flow chart that illustrates a process performed in accordance with some embodiments in the server computer of the computer system of FIG. 1.

FIG. 5 is a flow chart that illustrates additional details of the process of FIG. 4.

### DETAILED DESCRIPTION

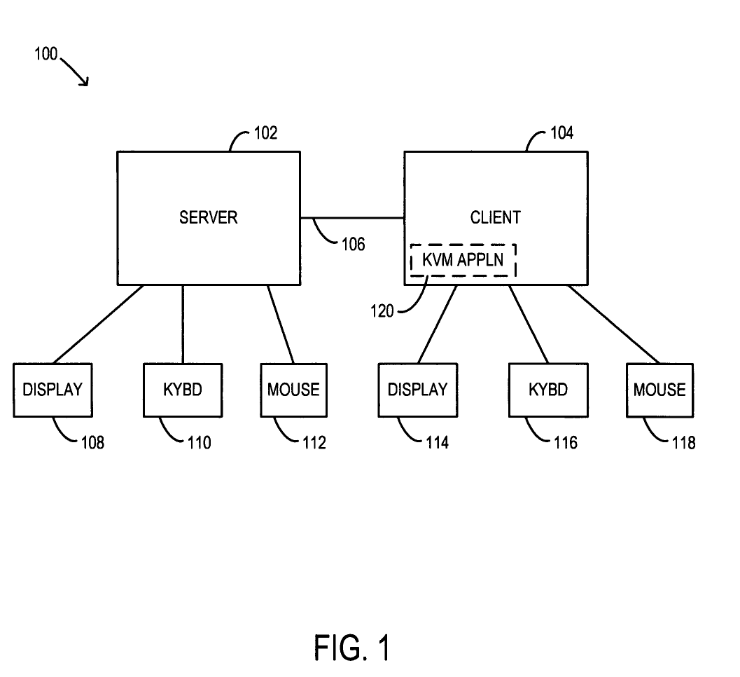

FIG. 1 is a block diagram of a computer system 100 provided according to some embodiments. The computer system 100 includes a server computer 102. The computer system 100 also includes a client computer 104 which may be in at least intermittent data communication with the server computer 102 via a data communication channel 106. The data communication channel 106 may be, for example, a Local Area Network (LAN).

A server video display monitor 108, a server keyboard 110 and a server mouse 112 may all be coupled to the server computer 102. A client video display monitor 114, a client keyboard 116 and a client mouse 118 may all be coupled to the client computer 104. At least part of the time, the client computer may execute a KVM application program 120 to allow KVM re-direction for the client I/O devices relative to the server computer 102. When KVM re-direction is occurring, the client mouse 118 may function as a remote mouse relative to the server computer 102.

Although only one client computer is shown in FIG. 1, it will be understood that the server computer 102 may be in at least intermittent communication with one or more other client computers, which are not shown. However, KVM re-direction will occur with respect to at most one client at any given time.

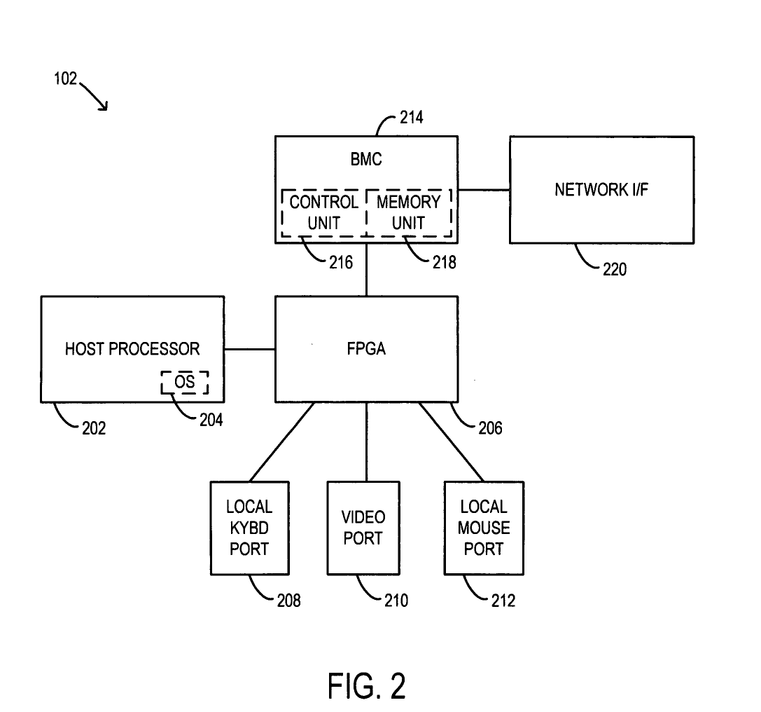

FIG. 2 is a block diagram showing some details of the server computer 102. The server computer 102 includes a host processor 202 (e.g., a conventional microprocessor) which executes an operating system 204. The server computer 104 further includes a field programmable gate array (FPGA) 206 which performs I/O functions for the server computer 102. The FPGA 206 is coupled to, and in at least intermittent communication with, the host processor 202.

The server computer 102 further includes a local keyboard port 208. The local keyboard port 208 is coupled to, and in at least intermittent communication with, the FPGA 206. The local keyboard port 208 has the server keyboard 110 (FIG. 1, not shown in FIG. 2) coupled thereto.

The server computer 102 also includes a video port 210. The video port 210 is coupled to, and in at least intermittent communication with, the FPGA 206. The video port 210 has the server video display monitor 114 (FIG. 1, not shown in FIG. 2) coupled thereto.

In addition, the server computer 102 includes a local mouse port 212. The local mouse port 212 is coupled to, and in at least intermittent communication with, the FPGA 206. The local mouse port 212 has the server mouse 112 (FIG. 1, not shown in FIG. 2) coupled thereto.

The server computer 102 also includes a baseboard management controller (BMC) 214. The BMC 214 may, for example, be a micro-controller integrated circuit that includes a control unit 216 to perform platform management functions for the server computer 102, and a memory unit 218 to store software and/or firmware instructions to program the control unit 216. (In accordance with instructions stored in the memory unit 218, the control unit 216 may operate to perform processes that are described below.) The BMC 214 is coupled to, and in at least intermittent communication with, the FPGA 206. The BMC 214 may be operative to monitor at least some communications between the FPGA 206, the host processor 202 and the server I/O devices 208, 210, 212.

Still further, the server computer 102 includes a network interface 220 by which the server computer 102 is coupled to the data communication channel 106 (FIG. 1, not shown in FIG. 2). The network interface 220 is coupled to, and in at least intermittent communication with, the BMC 214. The BMC 214 may be operative to receive, among other inputs via the network interface 220, KVM re-direction input signals that originate from the client computer 104 (FIG. 1). The BMC 214 may also operate to pass the KVM re-direction input signals to the FPGA 206, which in turn passes the KVM re-direction input signals to the OS 204. In accordance with some embodiments, and as described in more detail below, the BMC 214 may when necessary modify the format of inbound KVM mouse data packets so that the inbound KVM mouse data packets match the mouse data packet format expected by the OS 204.

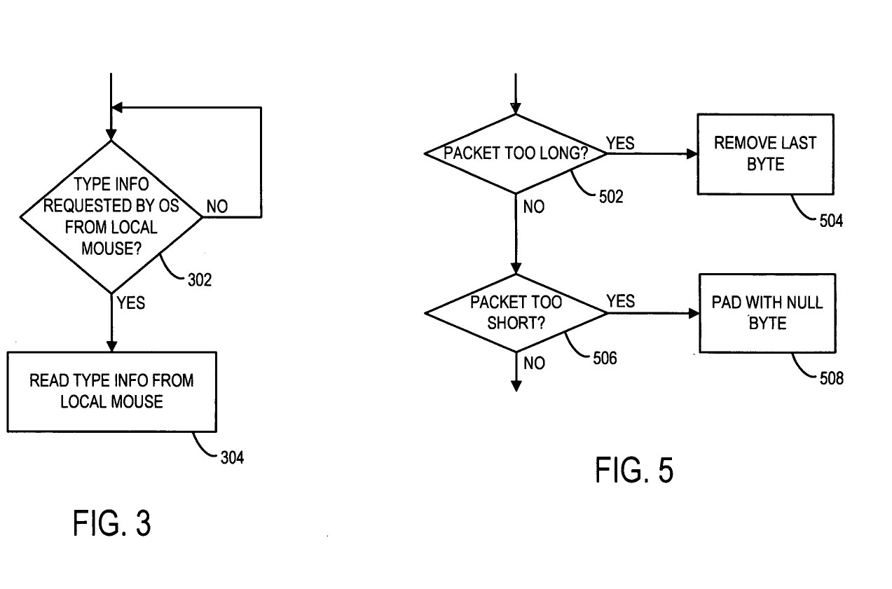

FIG. 3 is a flow chart that illustrates a portion of a start-up procedure performed in the server computer 102. In particular, the process of FIG. 3 reflects actions taken by the BMC 214 during start-up. At 302, the BMC 214 determines whether the OS 204 has requested that the server mouse 112 identify itself. If so, the BMC 214 monitors the communication traffic through the FPGA 206 to read, as indicated at 304, the mouse type information provided by the server mouse 112. From this information, the BMC 214 is able to determine what format the OS 204 will expect mouse data packets to be in. In particular, for some types of server mouse, the OS 204 will expect the mouse data packets to consist of three bytes, of which one byte conveys presses of two mouse buttons, and the other two bytes respectively convey X and Y direction movement of the server mouse. For other types of server mouse, the mouse data packets may in addition include a fourth byte, to convey additional mouse activities such as movement of a scrolling wheel switch. Thus, if the server mouse is of one type, the OS 204 will expect to receive 3-byte mouse data packets, and if the server mouse is of another type, the OS 204 will expect to receive 4-byte mouse data packets.

As a result of the process of FIG. 3, the BMC 214 detects (e.g., receives data indicative of) the type of the server mouse 112.

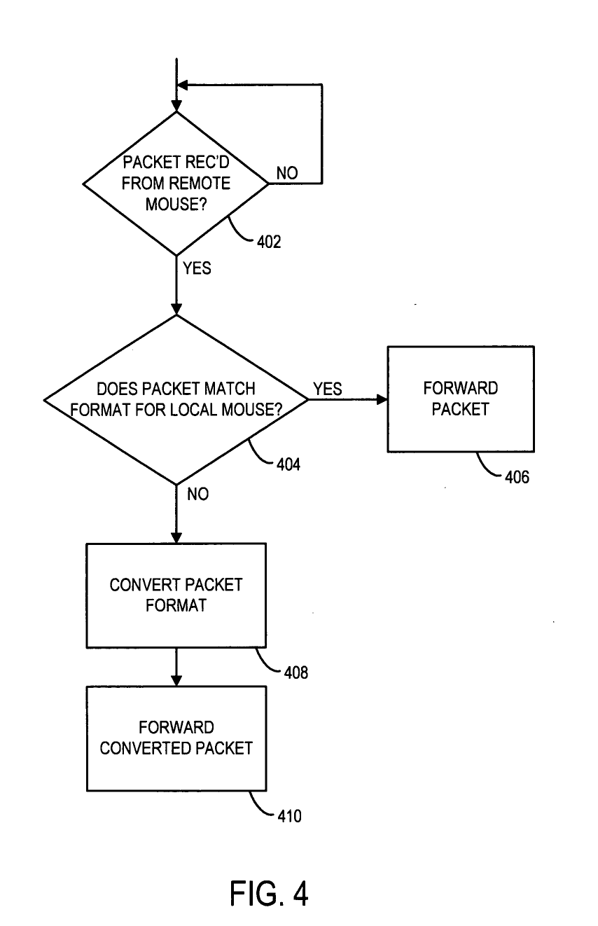

FIG. 4 is a flow chart that illustrates a process performed in accordance with some embodiments in the BMC 214 of the server computer 102. At 402, the BMC 214 determines whether it has received, via the network interface 220, a packet of mouse data that was originally generated by the client mouse 118 and that was transmitted to the server computer 102 for purposes of KVM re-direction to control the server computer 102 from the client I/O devices. If a positive determination is made at 402 (i.e., if a client mouse data packet is received at the server computer 102), then the BMC determines, at 404, and based at least in part on the detected type of the server mouse 112, whether the format of the KVM re-direction mouse data packet (client mouse data packet) matches the format for the mouse data that the server OS 204 expects to receive from the server mouse 112. If the KVM re-direction (client-originated) mouse data packet format matches the server mouse data packet format, then (as indicated at 406) the BMC 214 forwards the KVM re-direction mouse data packet to the FPGA 206. (The FPGA 206, in turn, forwards the KVM re-direction mouse packet to the OS 204.)

If at 404 the BMC 214 determines that the format of the KVM re-direction mouse packet does not match the server mouse packet format, then the BMC 214 proceeds, as indicated at 408, to convert the format of the KVM re-direction mouse packet to the format expected by the OS 204. Thus, at 404 the BMC 214 effectively determines whether to modify the format of the inbound KVM re-direction mouse data packet, and this determination is made at least in part on the basis of the detected type of the server mouse 112.

FIG. 5 is a flow chart that illustrates details of the conversion (modification) of the format of the inbound KVM re-direction mouse data packet, as performed at 408 in FIG. 4. Referring now to FIG. 5, at 502, the BMC 214 determines whether the format of the inbound KVM re-direction mouse data packet is too long. In other words, in some embodiments, the BMC 214 determines whether it is the case that the inbound KVM re-direction mouse data packet consists of four bytes after the BMC 214 had previously determined that the OS 204 expects the mouse data packet format to consist of three bytes. If such is the case, then (as indicated at 504) the BMC modifies the format of the inbound KVM re-direction mouse data packet by removing the last byte of the inbound KVM re-direction mouse data packet.

At 506, the BMC 214 determines whether the format of the inbound KVM re-direction data packet is too short. In other words, in some embodiments, the BMC 214 determines whether it is the case that the inbound KVM re-direction mouse data packet consists of three bytes after the BMC 214 had previously determined that the OS 204 expects the mouse data packet format to consist of four bytes. If such is the case, then (as indicated at 508) the BMC modifies the format of the inbound KVM re-direction mouse data packet by padding the packet with a null data byte. That is, a null data byte is appended to the packet.

Referring again to FIG. 4, after the BMC 214 modifies (converts) the format of the inbound KVM re-direction mouse data packet at 408, the BMC 214 forwards the modified packet to the FPGA 206, as indicated at 410. The FPGA 206 then, in turn, forwards the modified packet to the OS 204.

In embodiments described herein, the server BMC modifies, if necessary, the format of mouse data packets received for execution of KVM re-direction so that the modified format matches the mouse data format expected by the server operating system. As a result, even if the remote mouse does not match the local (server) mouse in type, the KVM re-direction mouse data actually forwarded to the server OS matches the expected mouse data format, and the mouse-type mismatch does not cause disruption of the server OS.

The term “mouse”, as used herein and in the appended claims, refers to any and all pointing devices used by a user of a computer to control movement of a cursor on a computer display monitor.

The several embodiments described herein are solely for the purpose of illustration. The various features described herein need not all be used together, and any one or more of those features may be incorporated in a single embodiment. Therefore, persons skilled in the art will recognize from this description that other embodiments may be practiced with various modifications and alterations.

What is claimed is:

1. A method comprising:
detecting a type of a first mouse;
receiving data generated by a second mouse; and
determining, based at least in part on the detected type of the first mouse, whether to modify a format of the received data.

2. The method of claim 1, further comprising:
modifying the format of the received data.

3. The method of claim 2, wherein the modifying includes appending a null byte to the received data.

4. The method of claim 2, wherein the modifying includes removing a byte from the received data.

5. The method of claim 1, wherein the first mouse is a local mouse and the second mouse is a remote mouse.

6. A baseboard management controller, comprising:
a control unit; and
a memory unit in communication with the control unit and storing instructions, the control unit operative with the instructions to:
detect a type of a first mouse;
receive data generated by a second mouse; and
determine, based at least in part on the detected type of the first mouse, whether to modify a format of the received data.

7. The baseboard management controller of claim 6, wherein the control unit is further operative with the instructions to:
modify the format of the received data.

8. The baseboard management controller of claim 7, wherein the modifying includes appending a null byte to the received data.

9. The baseboard management controller of claim 7, wherein the modifying includes removing a byte from the received data.

10. The baseboard management controller of claim 6, wherein the first mouse is a local mouse and the second mouse is a remote mouse.

11. A system comprising:
a baseboard management controller (BMC); and
a field programmable gate array (FPGA) in communication with the BMC;
the BMC including:
a control unit; and
a memory unit in communication with the control unit and storing instructions, the control unit operative with the instructions to:
detect a type of a first mouse;
receive data generated by a second mouse; and
determine, based at least in part on the detected type of the first mouse, whether to modify a format of the received data.

12. The system of claim 11, wherein the control unit is further operative with the instructions to:
modify the format of the received data.

13. The system of claim 12, wherein the modifying includes appending a null byte to the received data.

14. The system of claim 12, wherein the modifying includes removing a byte from the received data.

15. The system of claim 11, wherein the first mouse is a local mouse and the second mouse is a remote mouse.

16. An apparatus comprising:
a storage medium having stored thereon instructions that when executed by a machine result in the following:
detecting a type of a first mouse;
receiving data generated by a second mouse; and
determining, based at least in part on the detected type of the first mouse, whether to modify a format of the received data.

17. The apparatus of claim 16, wherein the instructions, when executed by the machine, further result in:
modifying the format of the received data.

18. The apparatus of claim 17, wherein the modifying includes appending a null byte to the received data.

19. The apparatus of claim 17, wherein the modifying includes removing a byte from the received data.

20. The apparatus of claim 16, wherein the first mouse is a local mouse and the second mouse is a remote mouse.
